(19) United States
(12) Patent Application Publication
(10) Pub. No.: US 2005/0173924 A1
(43) Pub. Date: Aug. 11, 2005

(54) SYSTEM AND METHOD FOR CHARGING A BATTERY IN A RECREATIONAL PRODUCT FROM AN ENGINE DRIVEN HIGH VOLTAGE CHARGING SYSTEM

(76) Inventor: Michael J. French, Pleasant Prairie, WI (US)

Correspondence Address: BOMBARDIER RECREATIONAL PRODUCTS INC.;INTELLECTUAL PROPERTY DEPT, PO BOX 230, NORTON, VT, 05907-0230, US

(21) Appl. No.: 10/708,071

(22) Filed: Feb. 6, 2004

(51) Int. Cl. H02M 5/45; H02M 5/458

(52) U.S. Cl. 290/1 A; 290/40 C; 363/37

(57) ABSTRACT

A system and method for charging a battery from an engine includes at least one battery disposed within a recreational product and configured to be charged by a charging voltage within a charging voltage range. The system includes an engine in operable association with the recreational product and configured to supply an internal rail voltage substantially greater than the charging voltage range and a converter system configured to convert the internal rail voltage to supply the at least one battery with charging voltage within the charging voltage range.

### BACKGROUND OF INVENTION

The present invention relates generally to combustion engines used in recreational products, such as outboard motors, and more particularly, to a system and method of charging an energy storage device, typically a battery, from an internal rail voltage that is greater than an acceptable input voltage for charging the battery. A converter is employed to condition direct current (DC) power so that the battery may be charged from the power generated by the combustion engine.

Modern watercrafts often include electric starting systems. Specifically, an outboard engine may include an internal battery to provide power to an electric starting system. During startup, power is drained from the battery. Once the combustion cycle has begun and the engine is in operation, power is delivered to the battery from the engine to recharge the battery. Specifically, engine operation delivers power to an internal rail of the engine, from which power is directed to charge the battery. By way of the internal rail, the engine also delivers the power necessary for the engine to perform. That is, the internal rail provides power to operate fuel injectors, fuel pumps, and the like, as well as the power to recharge the internal battery.

Additionally, modern watercrafts often include auxiliary systems and components that require power. During operation, the engine provides power to a wide variety of auxiliary components of the engine and the recreational product, such as lights, radios, CD and DVD players, televisions and the like. However, when the engine is not in operation, power may be directed to these auxiliary components via the internal battery of the recreational product. Therefore, in the case of an electric-start engine, the battery provides the power necessary to start the engine combustion and may also provide auxiliary systems with operational power when the engine is not in operation.

Further, modern engines and the equipment they are mounted in have a variety of needs that require more power. It is possible to provide the higher levels of power with larger alternators that are capable of producing more current at a standard voltage level; however, such alternators are large, heavy, and relatively expensive. It is far more economical and robust to provide a higher voltage power source and design a particular system component to operate that voltage, where practical. However, it is not practical, or economical, to provide every electrical component at that higher voltage. Further, some recreational products must interface with other products. For example, an outboard, sold by one manufacturer, must interface with a boat sold by another manufacturer. Accordingly, these products must have mating electrical systems, and while it may be advantageous for the outboard to run on a high voltage charging system, it would not be practical to require all boat manufacturers to convert boat electrical systems to that same higher voltage. Similarly, since 12 volt batteries have been widely accepted in the marketplace, it would be difficult to require a conversion to a higher voltage battery.

It would therefore be desirable to have a system and method to recharge a battery of a engine from an internal rail voltage that is higher than the voltage acceptable to charge the battery.

### BRIEF DESCRIPTION OF INVENTION

The present invention provides a system and method of charging an internal battery that overcomes the aforementioned drawbacks. Specifically, a power conditioner is employed to convert a rail voltage of an engine that is above an acceptable voltage necessary to charge the battery.

In accordance with one aspect of the current invention, a system for charging a battery from an engine is disclosed including at least one battery disposed within a recreational product and configured to be charged by a charging voltage within a charging voltage range. The system includes an engine in operable association with the recreational product and configured to supply an internal rail voltage substantially greater than the charging voltage range and a converter system configured to convert the internal rail voltage to supply the at least one battery with the charging voltage.

In accordance with another aspect of the current invention, a method of charging an engine battery is disclosed that includes generating an AC power with an engine of a recreational product and converting the AC power to a DC power that includes a substantially greater voltage than a charging voltage range of the engine battery. The method also includes supplying the DC power to an internal rail of the engine, receiving the DC power from the internal rail and regulating the DC power received from the internal rail to deliver a charging voltage within the charging voltage range.

In accordance with another aspect of the current invention, an outboard motor is disclosed that includes a powerhead having a combustion engine, a midsection configured for mounting the outboard motor to a watercraft, and a lower unit powered by the combustion engine to propel a watercraft. The outboard motor includes at least one battery only operable within a battery charging range and connected to provide starting power to the combustion engine. A converter is connected to the combustion engine and is configured to convert AC power supplied by the combustion engine to a DC power that includes a voltage that is above the battery charging range. A regulator is connected to the converter and configured to adjust the DC power to supply voltage within the battery charging range to the at least one battery.

Various other features, objects and advantages of the present invention will be made apparent from the following detailed description and the drawings.

### BRIEF DESCRIPTION OF DRAWINGS

The drawings illustrate one preferred embodiment presently contemplated for carrying out the invention.

In the drawings:

FIG. 1 is a perspective view of an exemplary outboard motor incorporating the present invention.

FIG. 2 is a block diagram of various subsystems of the outboard marine engine of FIG. 1.

FIG. 3 is a more detailed block diagram of a portion of that shown in FIG. 2.

### DETAILED DESCRIPTION

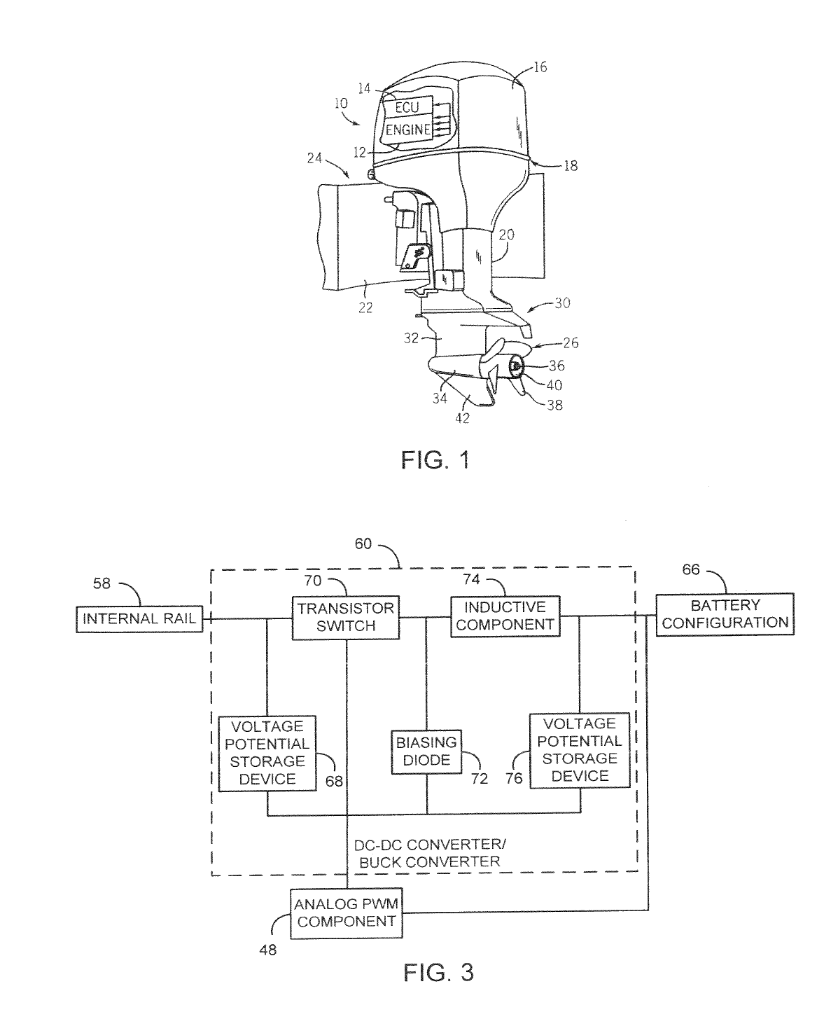

The present invention relates to internal combustion engines used in recreational products, and preferably, those incorporating fuel injection in a spark-ignited gasoline-type engine. FIG. 1 shows an outboard motor 10 having an engine 12 controlled by an ECU module 14 under engine cover 16. Engine 12 is housed generally in a powerhead 18 and is supported on a mid-section 20 configured for mounting on a transom 22 of a boat 24 in a known conventional manner. Engine 12 is coupled to transmit power to a propeller 26 to develop thrust and propel boat 24 in a desired direction. A lower unit 30 includes a gear case 32 having a bullet or torpedo section 34 formed therein and housing a propeller shaft 36 that extends rearwardly therefrom. Propeller 26 is driven by propeller shaft 36 and includes a number of fins 38 extending outwardly from a central hub 40 through which exhaust gas from engine 12 is discharged via mid-section 20. A skeg 42 depends vertically downwardly from torpedo section 34 to protect propeller fins 38 and encourage the efficient flow of outboard motor 10 through water. For purposes of this invention, engine 12 may be either a two-cycle or a four-cycle engine.

Some modern engines, such as the Evinrude® outboard motor, have fuel injectors that are extremely fast and responsive. Evinrude® is a registered trademark of the present assignee. These injectors are not only state-of-the-art in terms of performance, they are so highly tuned that engines so equipped greatly exceed environmental emissions standards for years to come. However, to obtain such exacting performance, the injectors operate at a rather high voltage, preferably 55 volts.

While the present invention is shown as being incorporated into an outboard motor, the present invention is equally applicable with other recreational products, some of which include inboard motors, snowmobiles, personal watercrafts, all-terrain vehicles (ATVs), motorcycles, mopeds, power scooters, and the like.

Therefore, it is understood that within the context of this application, the term “recreational product” is intended to define products incorporating an internal combustion engine that are not considered a part of the automotive industry. Within the context of this invention, the automotive industry is not believed to be particularly relevant in that the needs and wants of the consumer are radically different between the recreational products industry and the automotive industry. As is readily apparent, the recreational products industry is one in which size, packaging, and weight are all at the forefront of the design process, and while these factors may be somewhat important in the automotive industry, it is quite clear that these criteria take a back seat to many other factors, as evidenced by the proliferation of larger vehicles such as sports utility vehicles (SUV).

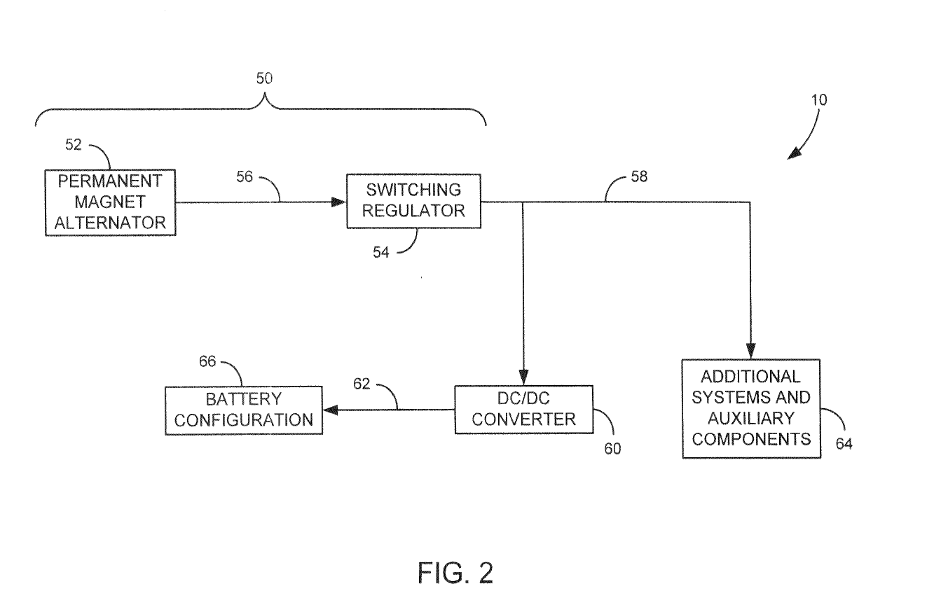

Referring to FIG. 2, some of the subsystems of outboard motor 10 of FIG. 1 are shown. Such non-automotive apparatuses include an AC power source and regulator 50, such as an alternator 52 and a high voltage output switching regulator 54, such as that described in commonly owned U.S. Pat. No. 6,066,941. Specifically, it is contemplated that the AC power source may be a multi-coil permanent magnet alternator 52 configured to deliver a variable output. That is, the multi-coil permanent magnet alternator 52 is configured with the switching regulator 54 to switch between electrical configurations of the coils of the multi-coil permanent magnet alternator 52. Therefore, as described in U.S. Pat. No. 6,066,941, it is possible to provide a variable output from the alternator 52 and control switching between various electrical configurations of the multiple coils of the multi-coil permanent magnet alternator 52 to optimize system operation.

The multi-coil permanent magnet alternator 52 is the primary electrical power output of the engine 12, which supplies raw AC power 56 to the switching regulator 54 which, in turn, delivers operational power to the systems and subsystems of the outboard motor 10. That is, when the outboard motor is operating, the stator of the multi-coil permanent magnet alternator 52 supplies AC power 56, which, as will be described, is converted to DC power, conditioned, and supplied as a first rail voltage 58 to a DC/DC converter 60 and other additional systems and auxiliary components 64. As will be described, the DC/DC converter 60 serves as a battery charging system to deliver a charging voltage within a charging range to a battery configuration 66.

Preferably, the first rail 58 delivers a “substantially greater” voltage than a second rail 62. That is, the power delivered by the first rail 58 includes a voltage level that is greater than the voltage delivered by the second rail 62. As such, if the battery configuration 66 was supplied with power directly from the first rail 58, the battery configuration 66 would be significantly damaged by the high voltage associated therewith. In accordance with a preferred embodiment, the first rail 58 carries a voltage of approximately fifty-five volts DC and the second rail 62 carries approximately twelve volts DC. In this case, the potential damaged caused by supplying the battery configuration with power directly from the first rail 58 would possibly render the battery configuration 66 permanently inoperable. Therefore, it should be understood that a voltage that is “substantially greater” than a battery charging voltage is a voltage that is potentially damaging to the battery operable at the battery charging voltage.

It is contemplated that the battery configuration 66 may be a single battery that is dedicated to the motor 10. However, it is also contemplated that the battery configuration 66 may include multiple batteries each of which can be charged with an appropriate charging voltage delivered by the DC/DC converter 60 simultaneously. Specifically, it is contemplated that a wide variety of batteries and battery configurations may be charged by the DC/DC converter 60. For example, the battery configuration 66 may include an internal battery for an electric-start system and additional batteries dedicated to auxiliary systems such as for back-up power, trolling motors, refrigerators, electric winches, and the like. As will be described, DC/DC converter 60 is capable of delivering the requisite charging voltage to numerous battery configurations.

Additionally, it is contemplated that the second rail 62, while configured to be utilized to deliver a charging power to the battery configuration 66, may also be utilized to deliver operational power to a wide variety of accessories of the recreational product which the engine is driving. In particular, it is contemplated that recreational product accessories such as lights, radios, CD and DVD players, televisions and the like may be supplied with operational power from the second rail 62. In this case, the power received from the first rail 58 includes a voltage that is substantially greater than an operational power range of the accessory and, as will be described, the DC/DC converter 60 operates to deliver the operational power within the operational power range to the accessory via the second rail 62.

When the engine is in operation, the ECU 22 controls the operation of all systems and auxiliary systems 60, 62 of the outboard motor 10. The ECU 22 controls the computer controlled switching regulator 54 to convert the AC power delivered by the permanent magnet alternator 52 to DC power. The switching regulator 54 is connected to the windings of the permanent magnet alternator 52 and consists of a plurality of rectifiers and computer controlled switches. To condition the AC power 56 supplied by the permanent magnet alternator 52, the ECU monitors the input power and controls the operation of a computer controlled switching regulator 54 according to at least one of a phase and a voltage level of the AC power 56. Specifically, the switching regulator 54 receives the AC power from the windings of the permanent magnet alternator and rectifies the AC power to supply DC power. The ECU monitors this process and upon receiving feedback indicative of a change in engine operating conditions, the ECU controls the computer controlled switching regulator 54 to dynamic adjustment an electrical configuration of the windings. That is, the switching regulator 54 is controlled to selectively open and close a plurality of switches which change an electrical configuration of the alternator windings to and from one of a series configuration, a parallel configuration, and a combination series and parallel configuration.

The DC/DC converter 60 reduces the voltage of the DC power supplied via the first rail 58 to a lower voltage that is supplied to the battery configuration 66, which is within a particular charging power range of the battery configuration. The DC/DC converter 60 is preferably a buck converter that conditions the power delivered from the internal rail 58 and delivers a suitable charging power to the battery configuration 66. As will be described, the buck converter uses a switch to regulate the voltage delivered to the battery configuration 66.

Referring to FIG. 3, a detailed block schematic of the DC/DC converter 60 of FIG. 2 is shown. In accordance with a preferred embodiment of the invention, the DC/DC converter 60 has a buck topology and functions as a buck converter 60. The buck converter 60 includes of a first voltage potential storage device 68, a switching transistor 70, a biasing diode 72, an inductive component 74, and a second voltage potential storage device 76.

The buck converter 60 receives DC power from the internal rail 58 as described with respect to FIG. 2. The first voltage potential storage device 68 serves to remove any residual fluctuations in the DC power received from the rail 58. When the transistor switch 70 is closed, allowing current flow through the inductive component 74 to the battery configuration 66, the magnitude of the current increases based on a time constant of the inductive component 50 and a resistance of the battery configuration 66. An analog pulse width modulation (PWM) component 78 is arranged to operate based on an output voltage supplied to the battery configuration 66. That is, when the voltage supplied to the battery configuration 66 begins to rise outside a charging power range, the analog PWM component causes the switch 70 to open and stop current flow from the internal rail input 58 through the inductive component 74.

However, though the transistor 70 stops the current flow through the inductive component 74, the inductive component 74 attempts to maintain the current flow by using the biasing diode 72 to direct the current out of the inductor to the battery configuration 66. As the current begins to decrease, the voltage provided to the battery configuration 66 begins to drop. Therefore, the power delivered to the battery configuration 66 begins to drop below the charging power range and the analog PWM component 78 causes the switch 70 to close.

The second voltage potential storage device 76 is placed in parallel with the battery configuration 66 to minimize any ripple resulting from the opening and closing of the transistor switch 70. FIG. 6 As such, the battery configuration 66 is supplied with a relatively constant DC voltage that is significantly lower than the DC input voltage from the internal rail 58 but that remains within the charging power range.

It is contemplated that the buck converter may be controlled to supply adequate charging power to multiple batteries simultaneously. Specifically, if the battery configuration 66 is a single battery, the charging power range includes a voltage between 13.5 volts and 15 volts along with approximately 25 amps. In a preferred embodiment, if the battery configuration 66 is a single battery, the ideal charging power to charge the battery 64 includes 14 volts at 25 amps. Therefore, if the battery configuration 66 is a single battery, it is possible to supply the battery with the approximate 12 volts DC necessary to effectuate charging from an internal rail voltage 58 of approximately 55 volts DC.

However, the system has the capacity to charge multiple isolated batteries. For example, in the case of two isolated batteries, the buck converter 60 is controlled such that 60 amps can be delivered to the battery configuration 66. Specifically, the analog PWM component 78 may be configured to control the transistor switch 70 to remain closed for a longer duration, thus, allowing the current to rise to the desired 60 amps. Therefore, it is contemplated that the above-described system may be configured to accommodate a plurality of batteries and battery configurations.

It is contemplated that the above-described technique may be embodied as a system for charging a battery from an engine including at least one battery disposed within a recreational product and configured to be charged by a charging voltage within a charging voltage range. The system includes an engine in operable association with the recreational product and configured to supply an internal rail voltage substantially greater than the charging voltage range and a converter system configured to convert the internal rail voltage to supply the at least one battery with the charging voltage.

It is further contemplated that the above-described technique may be embodied as a method of charging an engine battery including generating an AC power with an engine of a recreational product and converting the AC power to a DC power that includes a substantially greater voltage than a charging voltage range of the engine battery. The method also includes supplying the DC power to an internal rail of the engine, receiving the DC power from the internal rail and regulating the DC power received from the internal rail to deliver a charging voltage within the charging voltage range.

It is also contemplated that the above-described technique may be embodied as an outboard motor that includes a powerhead having a combustion engine, a midsection configured for mounting the outboard motor to a watercraft, and a lower unit powered by the combustion engine to propel a watercraft. The outboard motor includes at least one battery only operable within a battery charging range and connected to provide starting power to the combustion engine. A converter is connected to the combustion engine and configured to convert AC power supplied by the combustion engine to a DC power that includes a voltage that is above the battery charging range. A regulator is connected to the converter and configured to adjust the DC power to supply voltage within the battery charging range to the at least one battery.

The present invention has been described in terms of the preferred embodiment, and it is recognized that equivalents, alternatives, and modifications, aside from those expressly stated, are possible and within the scope of the appending claims.

1. A system for providing auxiliary power from an engine comprising:
at least one auxiliary component disposed within a recreational product and configured to be powered by a rated voltage within a rated voltage range;
an engine in operable association with the recreational product and configured to supply an internal rail voltage substantially greater than the rated voltage range; and
a converter system configured to convert the internal rail voltage to supply the at least one auxiliary component with the rated voltage.

2. The system of claim 1 wherein the recreational product is one of an outboard motor, a watercraft, an all-terrain vehicle, motorcycle, a scooter, a snowmobile, and a lawn and garden equipment.

3. The system of claim 1 further comprising a switching regulator to convert AC power from the combustion engine to DC power for the internal rail.

4. The system of claim 1 wherein the converter system includes a buck converter to regulate the internal rail voltage to supply the at least one auxiliary component with the rated voltage.

5. The system of claim 4 wherein the buck converter includes at least one discrete switch and a pulse width modulation control circuit configured to control the discrete switch to convert internal rail voltage to the rated voltage.

6. The system of claim 5 wherein the buck converter includes at least one inductive component configured to receive the rated voltage from the at least one discrete switch and regulate the rated voltage to stay within the rated voltage range.

7. The system of claim 1 wherein the internal rail voltage includes a voltage of greater than 36 volts DC.

8. The system of claim 1 wherein the combustion engine is a two-stroke engine.

9. The system of claim 1 wherein the at least one auxiliary component includes a first battery configured to start the combustion engine.

10. The system of claim 9 wherein the at least one auxiliary component includes a second battery.

11. The system of claim 1 wherein the at least one auxiliary component includes accessories of the recreational product.

12. The system of claim 11 wherein the accessories of the recreational product include at least one of a light, a radios, a CD player, a DVD players, and a television.

13. The system of claim 1 wherein the engine is a battery-less engine.

14. A method of powering a recreational product accessory comprising the steps of:
generating an AC power with an engine of a recreational product;
converting the AC power to a DC power that includes a substantially greater voltage than an operational voltage range of an accessory of the recreational product;
supplying the DC power to an internal rail of the engine;
receiving the DC power from the internal rail; and
regulating the DC power received from the internal rail to deliver an operational voltage within the operational voltage range.

15. The method of claim 14 wherein the DC power is includes at voltage level that would damage the accessory of the recreational product if supplied thereto.

16. The method of claim 14 further comprising the step of delivering a charging voltage from the operational voltage to a battery configuration to charge the battery configuration.

17. The method of claim 16 wherein the battery configuration includes at least one battery connected to start an outboard motor.

18. The method of claim 16 wherein the battery configuration includes at least a second battery not connected to start the outboard motor.

19. The method of claim 14 wherein the step of regulating the internal rail power includes pulse width modulating a discrete switch to deliver the operational voltage.

20. An outboard motor comprising:
a powerhead having a combustion engine, a midsection configured for mounting the outboard motor to a watercraft, and a lower unit powered by the combustion engine to propel a watercraft;
at least one battery only operable within a battery charging range and connected to provide starting power to the combustion engine;
a converter connected to the combustion engine and configured to convert AC power supplied by the combustion engine to a DC power includes a voltage that is above the battery charging range; and
a regulator connected to the converter and configured to adjust the DC power to supply voltage within the battery charging range to the at least one battery.

21. The outboard motor of claim 20 wherein the regulator is configured to receive the DC power from an internal rail of the outboard motor.

22. The outboard motor of claim 20 wherein the DC power includes a voltage greater than 36 volts DC and the battery charging range is 10-18 volts DC.

23. The outboard motor of claim 20 wherein the at least one battery includes at least a first battery configured to start the outboard motor and a second battery configured only for auxiliary equipment and wherein the first and the second batteries are electrically isolated.

24. The outboard motor of claim 20 wherein the regulator includes a buck converter connected to the at least one battery and configured to adjust the DC power to provide a voltage within the battery charging range.

25. The outboard motor of claim 20 wherein regulator is a switching regulator configured to switch an alternator winding configuration to and from at least two of a series configuration, a parallel configuration, and a combination of series and parallel configuration.

26. The outboard motor of claim 20 further comprising a multi-coil alternator connected between the combustion engine and the converter and configured to be driven by the combustion engine to generate the AC power.

27. The outboard motor of claim 20 wherein regulator is further configured to adjust the DC power to supply voltage within an operational range of at least one accessory external to the outboard motor to power the at least one accessory.
